(19) United States
(12) Patent Application Publication
(10) Pub. No.: US 2002/0129455 A1
(43) Pub. Date: Sep. 19, 2002

(54) Structure for CD/VCD cleaner

(76) Inventor: Yung-Feng Wei, Chu-Pei City (TW)

Correspondence Address: RABIN & CHAMPAGNE, PC, 1101 14TH STREET, NW, SUITE 500, WASHINGTON, DC, 20005, US

(21) Appl. No.: 09/739,398

(22) Filed: Dec. 19, 2000

(51) Int. Cl. B08B 1/04

(52) U.S. Cl. 15/102; 15/97.1

(57) ABSTRACT

The invention is to provide a kind of improved structure for a CD or VCD cleaner. The primary characteristics are to fasten a detergent container on the bottom of a box cover. The expansion tube on one end of the box cover is connected to a button, which is exposed to the groove of the box cover. One end of the expansion tube joins a nozzle through a detergent tube. By pushing the button, the expansion tube moves inward and certain amount of detergent is sprayed form the nozzle on the surface of the CD or VCD. Thus the dusts or spots on the surface of the CD or VCD is removed.

### FIELD OF THE INVENTION

The invention relates to a kind of improved structure for a CD or VCD cleaner, especially, to fasten a detergent container on the bottom of a box cover. The user can spray certain amount of detergent on the surface of a CD or VCD to clean the dusts or spots on the surface of a CD or VCD.

### BACKGROUND OF THE INVENTION

As shown in FIG. 6, a traditional CD or VCD cleaning box is to equip a rotary disk (101) inside the box body (100). The central axis of the rotary disk (101) joins a gear (102). A piece of CD or VCD 300 can be fixed onto the rotary disk (101) through the rear end of the gear (102). The bottom of a box cover (200) equips a rotary disk (201). The central axis of the rotary disk (201) joins a small gear (202). The outer rim of the gear (202) connects a large gear (203). The gear (203) fits the gear (not shown on the figure) at the top of a cleaning disk (204). A handle extrudes the outer box cover 200 from the top of the large gear (203). By holding the handle to rotate the large gear (203), the cleaning disk (204) and the small disk (202) rotate simultaneously. The small gear (202) fits the gear (102) on the box body (100). Thus, the rotary disk (101) makes the CD 300 rotate and the cleaning disk 204 clean the dusts on the surface of the CD300.

However, when the disk 204 cleans the surface of the CD 300; canned detergent 400 is required to be sprayed onto the surface of the CD 300. Because it is very difficult for a user to control the spraying distance and amount by using canned detergent, the amount of detergent on a CD 300 frequently varies. The effect in cleaning the dusts and spots on the surface of a CD or VCD declines. Moreover, an additional container is needed to store the detergent. It not only wastes spaces but also inconvenient for a user to find it.

Due to the above fact, the inventor conducts constant research and tests. Finally, the inventor develops a new kind of CD or VCD cleaner. The defectives of prior products are eliminated. The invention is much more useful.

### SUMMARY OF THE INVENTION

The primary objective of the invention provides a kind of improved structure for a CD or VCD cleaner, especially, to fasten a detergent container on the bottom of a box cover. By pushing a button, a user can spray a certain amount of detergent on the surface of a CD or VCD to clean the dusts or spots on the surface of the CD or VCD.

The secondary objective of invention is to provide a kind of improved structure for a CD or VCD cleaner, which equips a detergent container inside the cleaner. Thus, no detergent can is required. It will save space and very convenient for usage.

The following brief description for an optimal embodiment of the invention for better understanding to the structural assembly and application.

### BRIEF DESCRIPTION OF THE DRAWINGS

FIG. 1 is an appearance drawing of the invention.

FIG. 2 is a partial isometric drawing of the invention.

FIG. 3 is a structural drawing of the invent-ion in an open state.

FIG. 4 is a sectional plan of the invention.

FIG. 5 is the 5-5 section of FIG. 4 of the invention.

FIG. 6 is the structural drawing of the prior product.

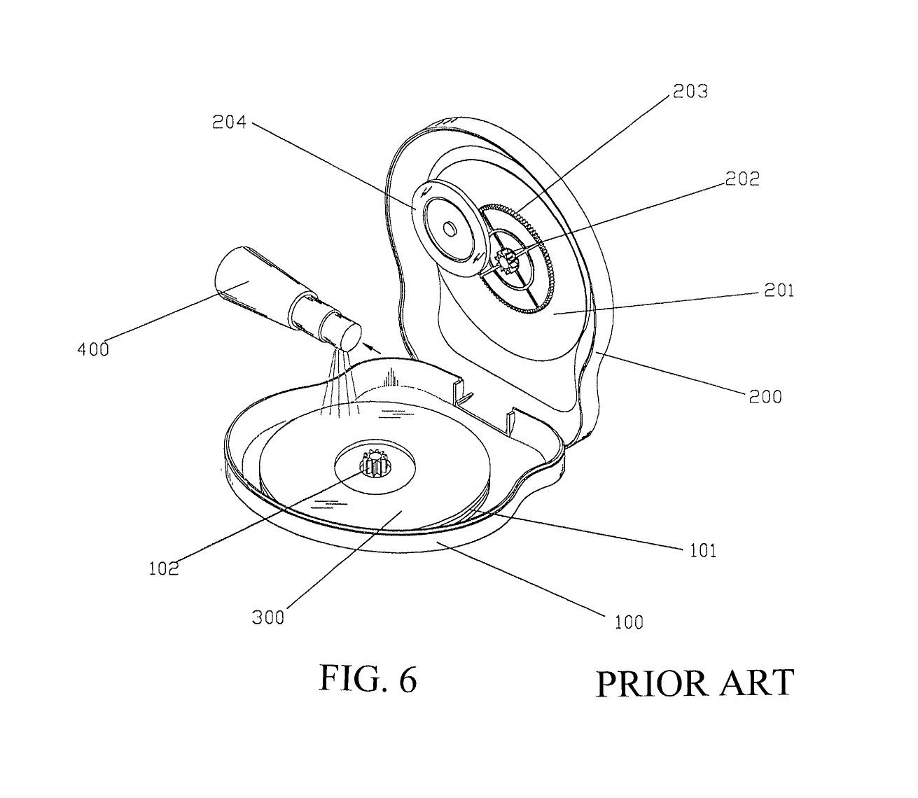

### BRIEF DESCRIPTION OF TERMS

| | | |
|---|---|---|
| (1) box body | (11) rotary disk | (12) gear |
| (13) groove | | |
| (2) box cover | (21) rotary disk | (211) fixed groove |
| (22) small gear | (23) large gear | (24) cleaning disk |
| (25) gear | (26) shift bar | (27) handle |
| (28) groove | | |

| | | |
|---|---|---|
| (3) detergent container | (31) can | |
| (33) button | (34) detergent tube | (35) nozzle |
| (4) screw stud | (41) stopper | |
| (5) screw | (51) washer | |
| (100) box body | (101) rotary disk | (102) gear |
| (200) box cover | (201) rotary disk | (202) small gear |
| (203) large gear | (204) cleaning disk | (300) CD |
| (400) spraying detergent | | |

### DETAILED DESCRIPTION OF THE PREFERRED EMBODIMENT

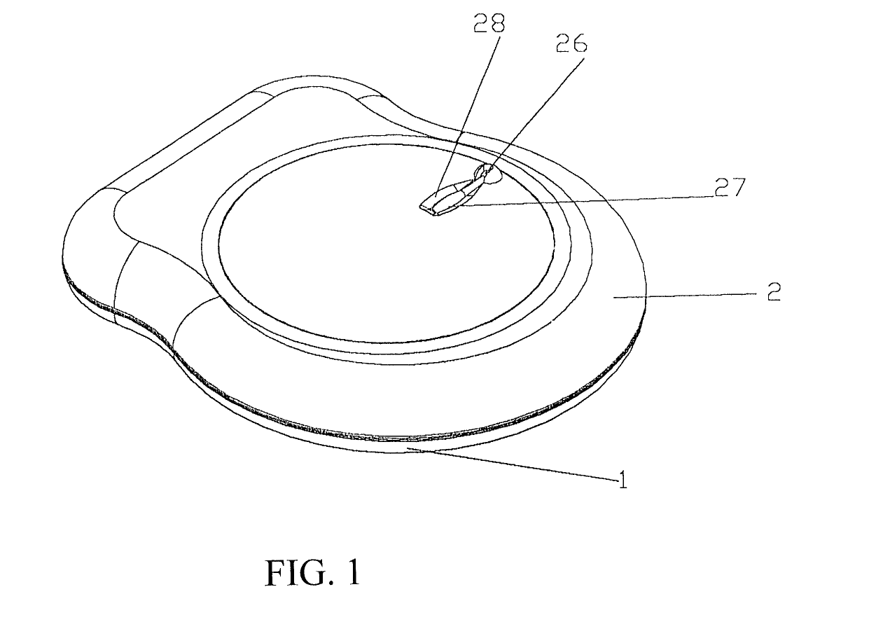

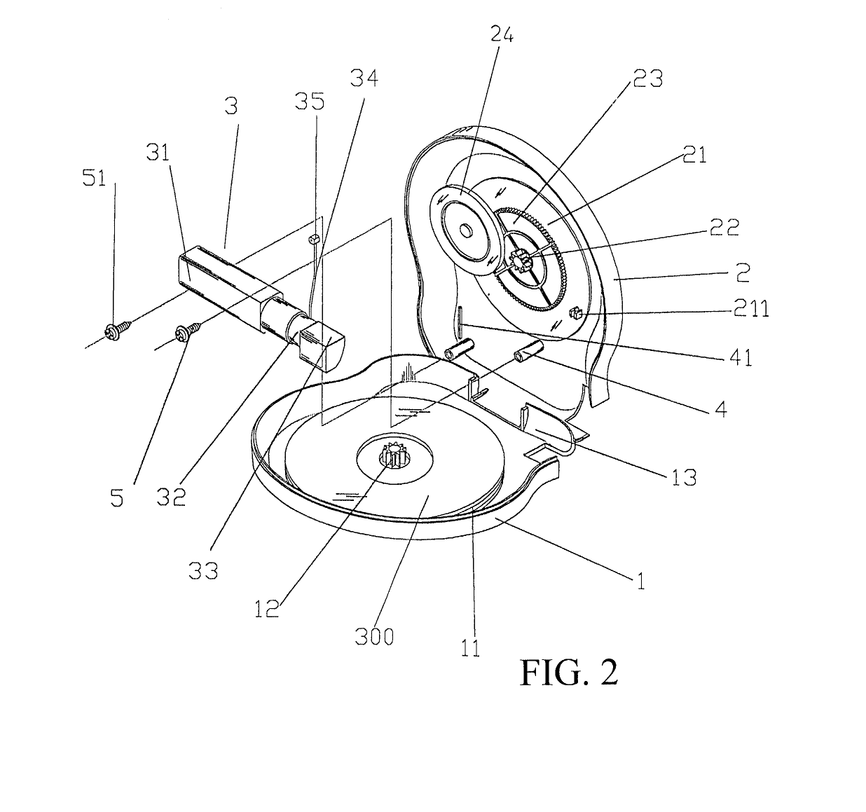

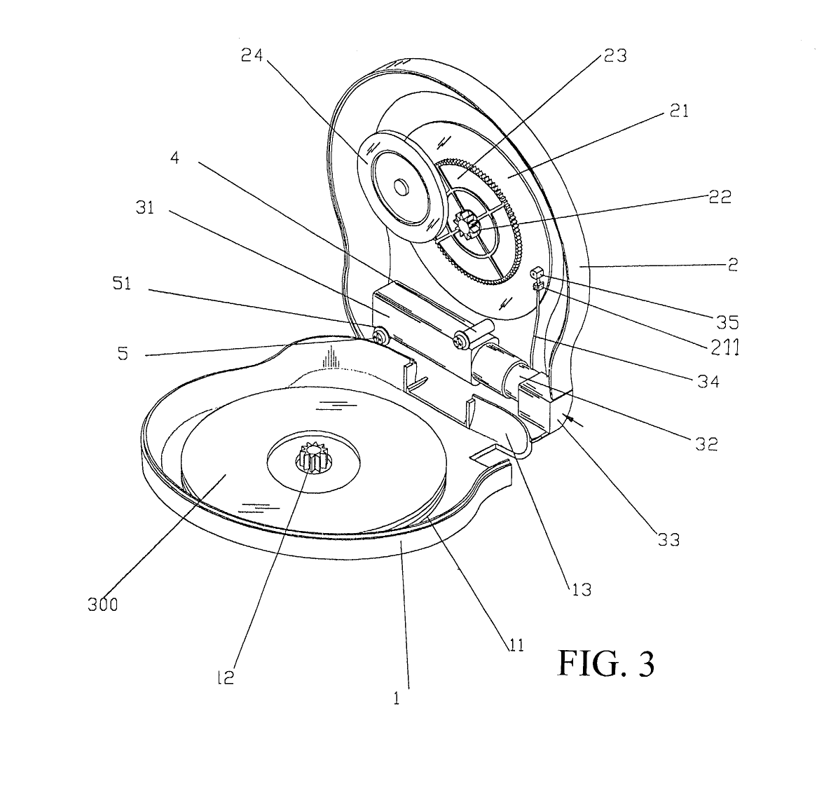

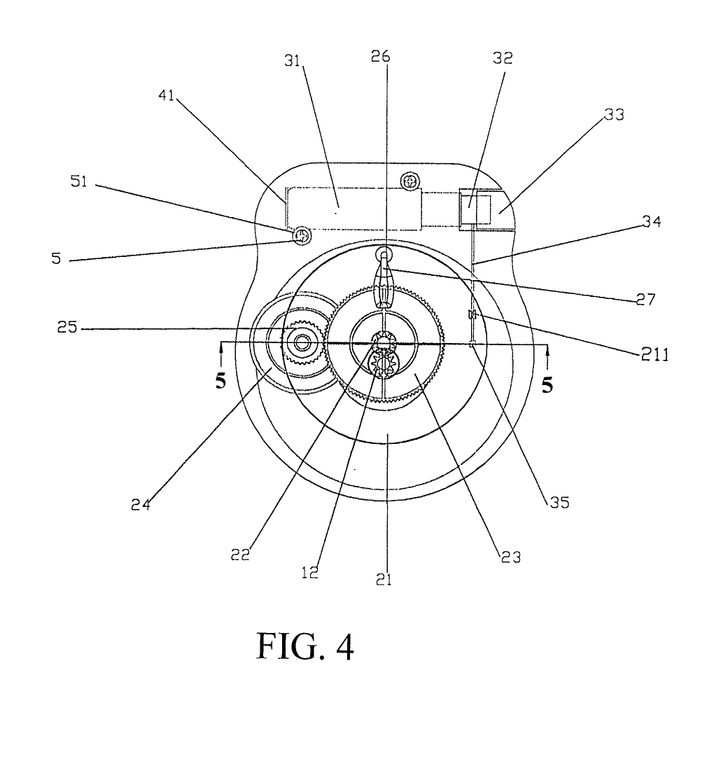

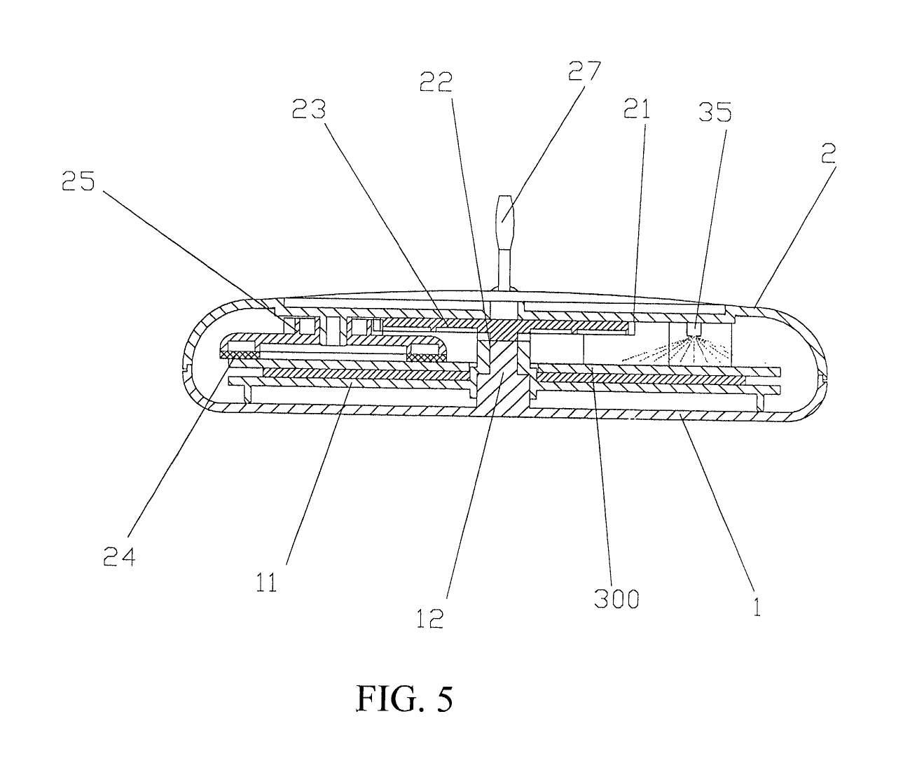

Please refer FIGS. 1 to 5. The invention comprises a box body (1), a box cover (2) and a detergent container (3). There is a pin to connect a box body (1) with a box cover (2). Thus, the box cover 2 can be opened form one end. The box body equips a rotary disk (11), which joins a gear (12) in the center. A CD or VCD 300 sets on the rotary disk (11) through the rear end of the gear (12). Similarly, the bottom of the box cover (2) equips a rotary disk (21), which is symmetrical to the rotary disk (11) on the box body (1). There is a pin to connect the center of the rotary disk (21) with a small disk (22), of them are joined a large gear (23). The gear (23) fits a gear (25) on the top of a cleaning disk (24) precisely. A shift bar (26) on the top of the rotary disk (21) extrudes the box cover (2) and joins a handle (27). Normally, the handle (27) is folded and laid on the groove (28) of the box cover (2). When it been using, one can pull it vertically, thus the shift bar (26) makes the large gear (23) rotate and the large gear (23) makes the gear (25) on the cleaning disk (24) rotate. At the meantime, the small gear (22) rotates with the gear (12) on the box body (1). Thus, the rotary disk (11) makes a CD or VCD rotate. The characteristics are illustrated as follows:

A detergent container (3) is fastened by a screw on the bottom of the box cover (2), which equips a screw stud (4) and a stopper (41). The end rectangular can (31 on the detergent container (3) is fixed between two screw studs (4) as shown FIG. (4). The end of can hits the stopper (41). Both of the screw (5) can be fixed inside the screw studs to fasten the can (31) by using a washer (51) on one end of the screw (5). An expansion tube (32) on one end of the detergent container (3) connects a button (33), which is located inside the groove (13) on one end of the box body (1). The expansion tube (32) joins a nuzzle (35) through a detergent tube (34). A nuzzle (35) is fastened on the fixed groove (211) on the rotary disk (21) to reach the surface of the CD 300. When a user pushes the button (33) to compress expansion tube (32), the detergent is sprayed on the CD 300.

In summary, the invention of improved structure for a CD or VCD cleaner is to equip a detergent container inside a cleaning box. Thus, certain amount of detergent can be evenly sprayed on the surface of a CD or VCD to effectively clean the spots and dusts on the surface of the CD or VCD. Besides, the detergent container is fixed inside the cleaning box. No spare space will be required. It is very convenient and to encounter finding it difficulty.

The above explanation is a substantial embodiment of the invention. The invention provides greater practicable than the prior ones. Furthermore, the present invention will to meet all new patent application requirements and lawfully submitted for reviewing and granting of the commensurate patent rights to thereby encourage the spirit of invention and its rightful protection under the patent law.

1. The invention relates a kind of improved structure for a CD or VCD cleaner comprises a box body, a box cover, and a detergent container, wherein The box cover can be opened from the box body and the rotary disk on the box body joins a gear to deposit a CD or VCD, wherein
The small gear at the center of the rotary disk on the box cover connects a large gear and joins a gear on the top of a cleaning disk, wherein
A shift bar on the top the rotary disk extrudes the box cover and a pin connect with a handle; thus when the handle is rotated, the bar makes the large gear rotate, which makes a cleaning disk and a gear on the cleaning disk rotate, wherein
At the meantime, the small gear rotates to make the gear on the box body rotating; thus the rotary disk makes a CD or VCD rotate with following characteristics: wherein
A detergent container is fastened on the bottom of the box cover, of which there are more than one set of screw studs on the bottom of the box cover and the can of a detergent container is fixed between the screw studs; furthermore, by using a screw, the can is fixed inside the studs and stopped by a screw washer; also, the expansion tube on one end of the can connects a button, which is located inside the groove of the box body and one end of the expansion tube connects a nuzzle with a cleaning tube; thus when the button is pushed, the expansion tube moves inward and the detergent is sprayed form the nuzzle onto the surface of a CD or VCD to clean the dusts and spots on the surface of the CD or VCD.

2. As mentioned in claim 1 of a kind of improved structure for a CD or VCD cleaner, of which the bottom of the box cover equips a stopper to hit and fasten the end of a can of a detergent container.
